(19) United States
(12) Patent Application Publication
(10) Pub. No.: US 2007/0023232 A1
(43) Pub. Date: Feb. 1, 2007

(54) Ladder caddy

(75) Inventors: Kenneth Brian Eastwood, Fort Collins, CO (US); Sondra Kay Eastwood, Fort Collins, CO (US)

Correspondence Address: CR MILES, P.C., 1 OLD TOWN SQUARE, SUITE 200 B, FORT COLLINS, CO, 80524, US

(73) Assignee: E5 Products, Inc.

(21) Appl. No.: 11/494,968

(22) Filed: Jul. 28, 2006

Related U.S. Application Data
(60) Provisional application No. 60/703,837, filed on Jul. 30, 2005.

(51) Int. Cl. E06C 5/00

(52) U.S. Cl. 182/127

(57) ABSTRACT

A ladder caddy which couples to a vehicle to provide at least one enclosed space configured to contain a ladder for transportation.

This United States patent application claims the benefit of U.S. provisional patent application 60/703,837, filed Jul. 30, 2005, hereby incorporated by reference herein.

### I. BACKGROUND

A ladder caddy which releasably secures to a vehicle to provide at least one enclosed space configured to contain a ladder for transportation.

Ladders comprise equipment commonly transported to and from construction or work sites. Conventional transportation of ladders typically involves placing the ladder(s) in the cargo space of the vehicle (such as the bed of a truck or the interior space of a station wagon or utility vehicle or the like), securing the ladder(s) to a roof top rack of the vehicle (such as tying the ladder(s) to the to the roof top rack or carrier with a rope, adjustable straps, bungee cords, or the like), or securing the ladder(s) to other types of conventional ladder racks (such as the conventional ladder rack connected to the vehicle shown by FIG. 1 in hash mark lines).

Even though there is large commercial market for ladder racks and even though manufacturers have met the demand of that commercial market with a variety of convention ladder racks, there are still a number of problems unresolved by conventional ladder racks or conventional carriers.

A significant problem with conventional carriers which releasably secures to a vehicle can be that the interior space of the conventional carrier is not configured to contain a ladder. Surprisingly, it appears that it has been entirely overlooked to configure a carrier releasably secured to a vehicle to contain a ladder within. However, even if the interior volume of a conventional carrier was increased sufficiently to locate a ladder inside, this approach would not address the various problems associated with transporting ladders as further described below.

Importantly, the well known conventional approach of transporting ladders secured to a framework of connected uprights and cross members connected to the vehicle, often referred to as a “ladder rack”, teaches away from containing the ladder(s) in an enclosed space or configuring an enclosed space to contain a ladder for transportation and to the extent that the disclosure or use of the conventional ladder rack teaches away from the instant ladder caddy invention it has made the solution afforded by the ladder caddy invention less obvious.

As to conventional ladder racks, a significant problem can be that that the framework of the conventional ladder rack does not provide any securement means. The lack of securement means necessitates the use of ropes, cords, adjustable straps, bungee cords, or the like, to secure the ladder(s) to the conventional ladder rack. However, even when secured to the conventional ladder rack as above-described, the ladder(s) may still shift on the conventional ladder rack or come loose during transit. The use of ropes, cords, adjustable straps, bungee cords, or the like also necessitates expenditure of a significant amount of time and effort to make certain that the ladders are properly secured.

Another significant problem with conventional ladder racks can that the conventional rack has a fixed configuration that may not accommodate the number or various configurations of ladders which are typically transported to and from the construction or work site. One aspect of this problem can be that ladder racks are not configured to stack ladders upon each one another for transportation. None-the-less, when several ladders must be transported using a conventional ladder rack, it may be that only way to accomplish the effort is by stacking of ladders upon each other. This only serves to exacerbate the difficulty of using ropes, cords, adjustable straps, bungee cords, or the like to properly secure the ladders to the ladder rack. Also, certain ladder configurations may be too short to allow securement of the laddder ends to the uprights or cross members of the conventional ladder carrier which further encourages short ladders to be stacked upon long ladders to allow securement.

Another significant problem with conventional ladder racks can be that the ladder being transported is exposed to the environment during transport. The transported ladder(s) can as a result get wet or collect material on the surface such as dirt, mud, grit, sand, bug carcasses, or the like. The exposure to moisture and the material(s) collected on the ladder surface may damage the ladder, result in increased wear of the ladder, or necessitate removal of the material further contributing to increased efforts or costs of transporting ladders in the conventional manner.

Another significant problem with conventional ladder racks can be the lack of security means to prevent or deter theft of the ladders. Conventional methods of securement such as ropes, straps, bungee cords, or the may not include security means. The ropes, straps, or bungee cords are simply removed and the ladder(s) can be immediately removed from the conventional ladder rack.

Yet another significant problem with conventional ladder racks can be the lack of compartmentalization. Conventional ladder racks or carriers typically provide cross members to which ladders and other material, such as lengths of pipe, sheet material, board material, or the like, are secured. The can result in the engagement of the various surfaces of the ladder(s) or other material(s) resulting in abrasion or impact damage as the ladder(s) or other materials shift during transit. Alternately, in those instances in which the uprights or cross members of the conventional ladder rack provide segregation means to secure, for example, the ladder(s) from the pipe(s), the segregation means may be a fixed configuration or a configuration which does not allow adjustment to a variety of ladder configurations.

Still another significant problem with conventional ladder racks along with the ladders or other materials secured to the conventional ladder rack can be the lack of aerodynamic configuration. The ladder(s) or other material(s) generate resistance to the flow of air across the corresponding surfaces which can create turbulence sufficient to effect travel of the vehicle, or generate travel, flexure, or shift in the ladder(s) or other material(s) which can result in damage to the vehicle, the ladders, or the materials during transit.

### II. SUMMARY OF THE INVENTION

Accordingly, a broad object of the invention can be to provide a ladder caddy which releasably secures to a vehicle which provides at least one enclosed space configured to contain a ladder.

A second broad object of the invention can be to provide a ladder caddy which has at least one enclosed space configured to secure a ladder within without the use of ropes, cords, adjustable straps, bungee cords, or the like.

A third broad object of the invention can be to provide a ladder caddy which provides a plurality of discrete enclosed spaces each configured to contain a ladder. The plurality of enclosed spaces can be joined to in a manner which provides a wall, partition, divider, or the like, between each of the plurality of enclosed spaces which act to prevent the surfaces of the plurality of ladders contained within from engaging to avoid or minimize abrasion or impact damage.

A fourth broad object of the invention can be to provide a ladder caddy which allows a plurality of ladders to be stacked one above the other and secured without the use of ropes, cords, adjustable straps, bungee cords, or the like.

A fifth broad object of the invention can be to provide a ladder caddy having a plurality of enclosed spaces each differently configured to contain a variety of ladder configurations. One aspect of this object of the invention can be to provide interchangeable enclosed spaces which allows the user to select the configuration of ladder caddy most useful to a particular application.

A sixth broad object of the invention can be to provide a ladder caddy having at least one enclosed space configured to contain a ladder which further provides a lockable closure.

A seventh broad object of the invention can be to configure the exterior surface of the ladder caddy to reduce resistance to airflow and to improve handling characteristics of the vehicle.

Naturally, further objects of the invention are disclosed throughout other areas of the specification, drawings, photographs, and claims.

### III. A BRIEF DESCRIPTION OF THE DRAWINGS

FIG. 1 is a perspective view of a conventional vehicle joined to a conventional rack of upright members and cross members shown in hash marked lines to which a particular embodiment of the ladder caddy invention can be releasably secured to provide an enclosed space configure in which a ladder can be removably contained.

FIG. 2A is a perspective view of a particular embodiment of the ladder caddy invention.

FIG. 2B is a top view of the particular embodiment of the ladder caddy invention shown by FIG. 2A.

FIG. 3A is cross section view 3a-3a of the particular embodiment of the ladder caddy invention shown by FIG. 2B.

FIG. 3B is an enlarged area of cross section 3a-3a showing a particular embodiment of a lockable closure.

FIG. 3C is an enlarged area of cross section 3a-3a showing a second particular embodiment of a lockable closure.

FIG. 4 is a perspective view of an alternate embodiment of the ladder caddy invention which provides a common closure to a plurality of enclosed spaces each configured to contain a ladder.

### IV. DETAILED DESCRIPTION OF THE PREFERRED EMBODIMENTS

A ladder caddy which releasably secures to a vehicle to provide at least one enclosed space configured to contain a ladder.

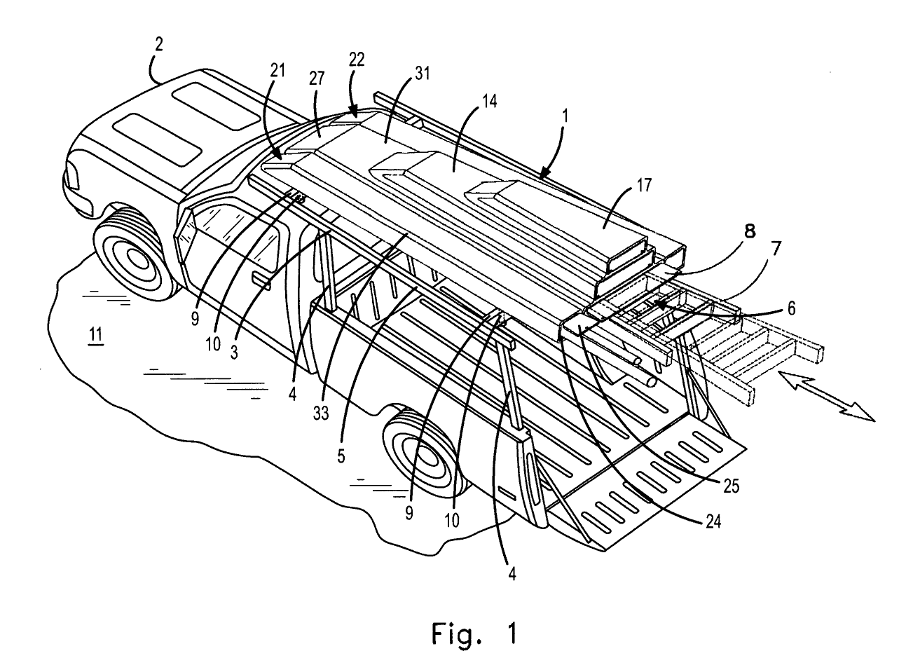

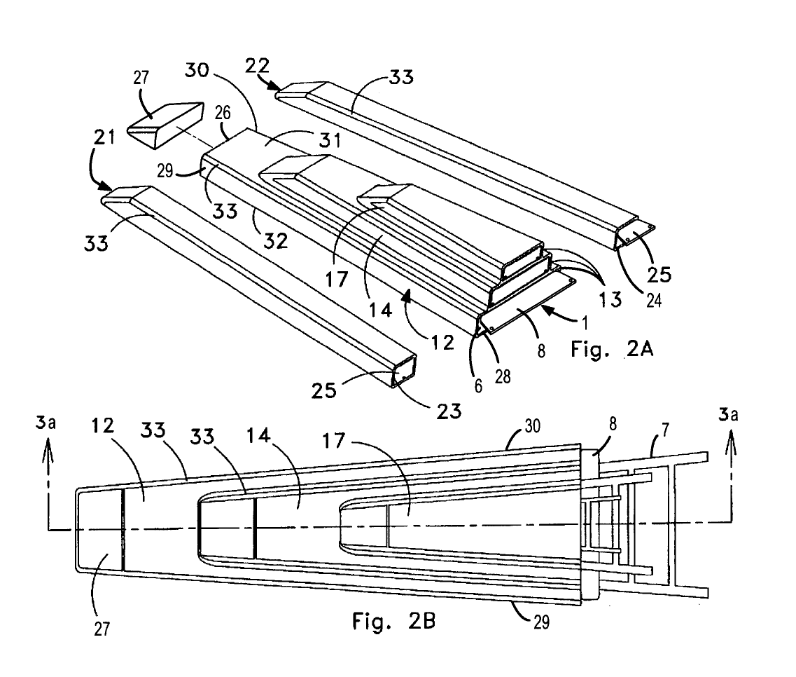

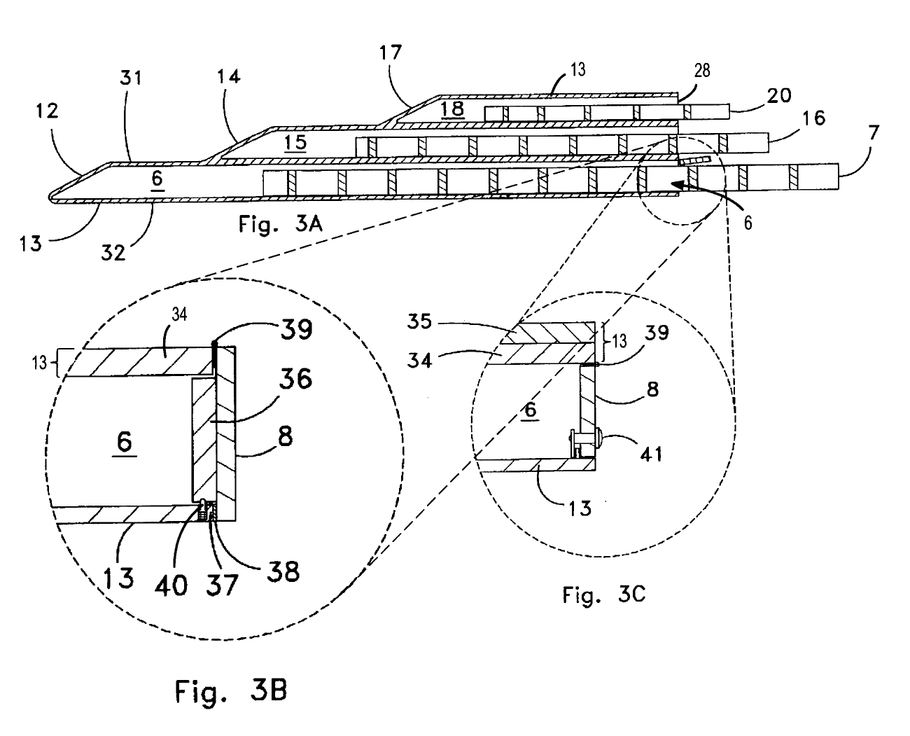

Now referring primarily to FIG. 1, a particular embodiment of the ladder caddy (1) is shown mounted to a vehicle (2). The ladder caddy (1) can provide at least one enclosed space (6) (see FIG. 3A as a non-limiting example) configured to removably contain at least one ladder (7). Each enclosed space (6) can further include a closure element (8) which operates between a closed position (see FIG. 2A as a non-limiting example) and an open position (as shown by FIG. 1) to provide the open condition and the closed condition of the ladder caddy (1) which allows a ladder (7) to removably stow (insert and remove from the enclosed space) in the enclosed space (6).

Again referring to FIG. 1, a particular method of using the ladder caddy (1) can include releasably securing the ladder caddy (1) to the vehicle (2). As shown by FIG. 1, as a non-limiting example, the ladder caddy (1) can be secured to a mounting surface (9) of a vehicle rack (3) utilizing a mount (10)(for example, one or more mechanical fasteners) to locate the plane defined by the bottom surface of the ladder caddy (1) substantially horizontal (or at a desired angle) to the support surface (11) on which the vehicle (2) travels.

The vehicle (2) and the vehicle rack (3) as shown in FIG. 1 are not intended to be limiting with respect to the numerous and wide variety of vehicles (2) and vehicle racks (3) to which the ladder caddy (1) can mount. For example, the vehicle (2) can be any conveyance which transports persons or objects, such as a pick up truck, a utility van, a station wagon, or the like. The vehicle rack (3), when utilized with the ladder caddy (1), can comprise any constructional form of a material which provides a securable interface between the ladder caddy (1) and the vehicle (2). Certain vehicle racks as shown in FIG. 1 can provide a plurality of the horizontal cross members (5) which are held in fixed relation to the vehicle (2) by a plurality of vertical members (4).

The term “mount” or “mounting” encompasses attachment of the ladder caddy (1) directly to the vehicle (2) or indirectly to the vehicle (2) by attachment to the vehicle rack (3) or by other interface with the vehicle. The attachment while typically releasable for removal of the ladder caddy (1) from the vehicle (2) does not preclude permanent attachment of the ladder caddy (1) to the vehicle (2). For example, a suitable mechanical fastener (10) such as spirally threaded bolts which pass through the horizontal members (5) of the vehicle rack (3) at one or more locations and mate with corresponding spiral threads coupled to the ladder caddy (1) can be utilized; however, a wide variety of alternative mechanical fasters (10) can be suitable depending upon the particular embodiment of the ladder caddy (1) and the particular mounting surface (9) including but not limited to U-bolts, lag bolts, studs and wing nuts having mated spiral threads, compression bands, or the like.

By opening the at least one closure element (8)(or “closure element”) of the ladder caddy (1) an enclosed space configured to contain the ladder (7) can be accessed and the ladder (7) can be removably stowed within the enclosed space (6) of the ladder caddy (1). By closing the closure element (8) the ladder (7) can be contained inside the enclosed space (6) of the ladder caddy (1). Locking the closure element (8) secures the closure element (8) in the closed condition until unlocked by the user. Transporting the ladder (7) contained inside the enclosed space (6) can be achieved by operating the vehicle (2) in the typical manner.

Upon arriving at the desired destination, unlocking the closure element (8) or opening the closure element (8) provides access to the enclosed space (6) configured to contain the ladder (7). Removing the ladder (7) can be achieved by applying sufficient forces (shown by directional arrow in FIG. 1) to the ladder (7) at the end proximate the closure element (8) to allow the ladder (7) to be withdrawn from the enclosed space (6) of the ladder caddy (1).

Now referring primarily to FIG. 2A, a basic embodiment of the ladder caddy (1) includes a ladder caddy body (12) having a ladder caddy body wall (13) and a closure element (8) coupled to the ladder caddy body wall (13). When the closure element (8) is in the closed position, the closed condition of the ladder caddy body (12) provides an enclosed space (6) configured to contain a ladder (7). The enclosed space (6) configured to contain a ladder (7) means that the outside surface of the ladder caddy body wall (13) has a configuration which substantially matches the configuration of the ladder or the range of ladders (compensating for the ladder caddy body wall thickness) to be stowed to reduce the external volume of the ladder caddy (1) with the inside surface of the ladder caddy body wall (13) defining a volume sufficiently large to allow the particular ladder (7) to be removably stowed. Configuring the ladder caddy to the ladder being stowed provides the advantages of lowered wind resistance and a smaller footprint which increases the amount of area remaining for other materials or objects to be attached to the vehicle or vehicle rack and are points of differentiation from conventional luggage carriers which are not configured in any particular fashion and certainly not to stow ladders.

Alternate embodiments of the ladder caddy (1) can comprise a pair or a plurality of ladder caddy bodies (12)(14)(17) permanently or removably coupled together. For example, a first ladder caddy body (12) having a ladder caddy body wall (13)(see also FIG. 3A) can define a first enclosed space (6) configured to contain a ladder (7). A second ladder caddy body (14) can be coupled (or releasably coupled) to the first ladder caddy body (12) to provide a second enclosed space (15)(see FIG. 3A) configured to contain a second ladder (16). Similarly, a third ladder caddy body (17) can be coupled (or releasably coupled) to the second ladder carrier body (18) to provide a third enclosed space (19)(See FIG. 3A) configured to contain a third ladder (20).

Various configurations of the ladder caddy (1) can be configured with greater or lesser numbers of ladder caddy bodies (12)(14)(17) and the embodiment of the ladder caddy invention (1) shown by FIG. 2A is not intended to limit the invention to a particular number of ladder caddy bodies and the invention can comprise one, a pair, or a plurality of ladder carrier bodies. Moreover, as to certain embodiments of the invention, the first ladder caddy body (12) and the second ladder caddy body (14) can be produced as discrete ladder caddy bodies (12)(14)(17) and then coupled (releasably coupled) together to generate various combinations or permutations of the ladder caddy (1), or alternately the first ladder caddy body (12) and the second ladder caddy body (14) (or any number of ladder caddy bodies) can be produced as a single integral piece in a fixed configuration.

Each ladder caddy body (12)(14) or (17) can be produced without limitation from metal, plastic, fiberglass with epoxy resin, or the like, whether molded, formed, or otherwise fabricated (such as injection molded, vacuum formed, or the like) to provide a discrete integral ladder caddy body (14) which encloses a space configured to contain a single ladder (7) and in alternate embodiments can be coupled together to provide a plurality of ladder caddy bodies, or which encloses a space configured to contain a plurality of ladders each of the ladders held a distance apart to prevent engagement of the surface of one ladder with another ladder when stowed.

Again referring primarily to FIG. 2A, the ladder caddy (1) can further comprise a first outlier caddy (21) having an outlier wall (23) which defines an outlier enclosed space (24) configured to contain materials inside such as pipe, rod, or the like. The first outlier caddy (21) can be coupled to the first ladder caddy body (12)(or second or third ladder caddy body) or can be separately coupled to the mounting surface (9) of the vehicle (2) or the vehicle rack (3)(which as to some racks can be at one or more locations on a plurality of the horizontal cross members) by a plurality of mechanical fasteners (10) to position the plane defined by the outlier caddy body substantially horizontal to the support surface (11) which engages the vehicle (2)(as shown for example by FIG. 1). As shown by FIGS. 1 and 2A, a second outlier caddy (22) can further be coupled to the ladder caddy body (12)(or second or third ladder caddy body) or to the mounting surface (9) of a conventional vehicle (2) or vehicle rack (3)(or other suitable surface of the vehicle (2)). Each outlier caddy body (21) or (22) can have outlier caddy closure (25) which travels between a closed position and an open position to allow access to the outlier enclosed space (24). While the first and the second outlier caddy (21)(22), are both shown by FIG. 2A, this is intended to be illustrative of the numerous and varied configurations of the outlier caddy (21) or (22). For example, the ladder caddy (1) can be utilized without any outlier caddy (21) or (22), or with a pair of outlier caddies (21) and (22) as shown by FIG. 1, or with a plurality of outlier caddies (not shown).

Each outlier caddy body (21)(22) can be produced without limitation from metal, plastic, fiberglass with epoxy resin, individually or in combination, whether molded, formed, or otherwise fabricated to provide a single integral piece or to provide a plurality of pieces which can be assemble to produce the outlier caddy body (21).

Now referring again primarily to FIG. 2A, a particular embodiment of the ladder caddy (1) can provide a ladder caddy body (12) having ladder caddy body wall (13) configured to define a substantially trapezoidal volume as the enclosed space (6) (see also FIG. 3A) to contain a ladder (7) which defines the planes of a trapezoidal volume, whether in the unfolded (as shown in Figures) or in the folded condition (the ladder can be folded to a configuration which defines a trapezoidal volume). A basic embodiment of the substantially trapezoidal volume of the ladder caddy body (1) provides a trapezoidal top (31) and a trapezoidal bottom (32). Each of the trapezoidal top (31) and the trapezoidal bottom (32) are shown in the Figures as isosceles trapezoids; however, the term trapezoidal as used herein includes minor variations in constructional form consistent with ordinary manufacturing practice which may result in minor variance in the angles of the base pair of angles of the trapezoidal bottom (32) and the trapezoidal top (31) which may be as much as five degrees difference. The trapezoidal top (31) and the trapezoidal bottom (32) can be held a distance apart in substantially parallel disposition by a pair of rectangular side panels (29)(30) and a rectangular end panel (26) thereby providing a rectangular end aperture (28) having an open condition (as shown by FIG. 3A) and a closed condition (see FIG. 2A) by operation of the closure element (8) between an open position and a closed position. Now again referring to FIGS. 2A and 2B, the rectangular end panel (26) of the ladder caddy body (12) can be joined between the trapezoidal top (30) and the trapezoidal bottom (31) to establish an inclined surface (27)(alternate embodiments of the ladder caddy body shown in FIG. 2A).

The rectangular end panel (26) can be configured to define a rectangular area of about twelve inches to about twenty four inches in width and about six to about twelve inches in height. The rectangular end aperture (28) can be configured to define a rectangular area of about eighteen inches to about thirty six inches in width and about six to about twelve inches in height. The rectangular end panel (27) and the rectangular end aperture (28) (which can further operate as the closure (8)) can be established a distance apart based upon the length of the ladder (7) to be contained in the enclosed space (6). As such, the rectangular end panel (26) and the rectangular end aperture (28) can be established about four feet to about thirty feet apart. The ladder caddy body wall thickness (13) can be uniform, and with respect to certain molded, formed, or fabricated embodiments of the ladder caddy body (12) can be between about one-eighth inch and about one quarter inch in thickness depending upon the type of material utilized. As to certain embodiments of the ladder caddy (1), the rectangular body panel (26), the rectangular side panels (29)(30), the trapezoidal top (31), and the trapezoidal bottom (32) can join in an angled or arcuate edge (33).

This particular trapezoidal embodiment of the ladder caddy (1) is not intended to be limiting with respect to the numerous configurations of the ladder caddy body (12)(14)(17)(or other caddy body configuration) encompassed by the ladder caddy (1) invention. The ladder caddy (1) can be configured in any manner which affords an enclosed space (6)(15)(18)(or other enclosed space) configured to contain a ladder (7). As such, certain embodiments of the ladder caddy (1) can be configured as a rectangular volume or plurality of rectangular volumes, for example, instead of a trapezoidal volume or a plurality of trapezoidal volumes as shown, which releasably couple to a vehicle (2) or vehicle rack (3), whether separately, combined or coupled together in various permutations or combinations, or as a single integral piece.

Now referring primarily to FIG. 3A, as shown by the cross section 3a-3a, the ladder caddy body (12)(14) or (17) defines a plurality of discrete enclosed spaces (6)(115) or (18) in which the ladder (7)(16)(20) of corresponding configuration can be removably stowed. The enclosed space (6)(15) or (18) (or other enclosed space configured to contain a correspondingly configured ladder (7)) can typically comprise the volume of the ladder caddy body (12)(14) or (17)(or other ladder caddy body) less the thickness of the body wall (13). As shown, each ladder caddy body (12)(14) or (17) can be molded, formed or fabricated as a single discrete ladder caddy body (12)(14)(17) of a particular configuration (whether an integral single piece or a plurality of pieces which are assembled to provide each discrete ladder caddy body) or as a single discrete ladder caddy body of a particular configuration which provides a plurality of enclosed spaces (6)(15)(18)(as shown or having greater or fewer enclosed spaces) each of which can contain a ladder. Alternately, a plurality of discrete ladder caddy bodies can be coupled, in which case, the ladder caddy body (1) wall (13) thickness between enclosed spaces ((6) and (15) for example) can comprise a first layer (34) including the body top (31) of a first ladder caddy body ((12) for example) and a second layer (35)(see for example FIG. 3B) including the body bottom (32) of a second ladder caddy body ((14) for example).

Now referring to FIGS. 3B and 3C, numerous and varied configurations of the closure element (8) can be coupled to the ladder caddy body (12) or (14)(17) to allow access to the enclosed space (6) or (15)(18) in which a ladder (7) can be contained. For example, as shown by FIG. 3B the closure (8) can further include a closure relief element (36) configured to socket with the rectangular end aperture (28) as the closure element (8) travels toward the closed position. The closure relief element (36) configured as shown can further act as a structural element which assists in maintaining the configuration of the ladder caddy. By providing the closure relief element (36), the closure element (8) can engage the terminal edge (37) of the ladder caddy body walls (13). A gasket (38) can be located between the terminal edge (37) of the ladder caddy (1) walls (13) and the closure element (8). A hinge (39) can be coupled between the ladder caddy body wall (13) and the closure (8) to allow the closure element (8) to allow rotation about a pivot axis as the closure element (8) travels from the open position to the closed position or from the closed position to the open position. The hinge (39) can comprise for example a length of piano hinge, a pair of hinges established a distance apart, a flexible portion of the ladder caddy body wall (13) which can be molded or formed as a single integral piece with the closure (8), or can be a separate flexible material coupled between the ladder caddy body wall (13) and the closure element (8).

Alternately as shown by FIG. 3C, the closure can be configured to operably locate inside the rectangular end aperture (28) of the ladder caddy body (12) in the closed position. As discussed above, the closure element (8) can further provide a hinge (39) coupled between the ladder caddy body wall (13) and the closure element (8). As to any of the many configurations of the closure element (8), the closure element (8) can be forcibly urged to mate or pass over a detent (40) or a plurality of detents to retain the closure (8) in the closed position during transport of the ladder (7) contained in the enclosed space (6). Other closure retention elements can be used which act to restrict the closure element (8) to the closed position during transport of a ladder (7) including mechanical latches, keyed latches, catches, bolts, bullet catches, hasps, keyed hasps, or the like. A keyed lock (41), or similar lock element, can further be included to prevent operation of the closure without utilizing a key, or other identification element.

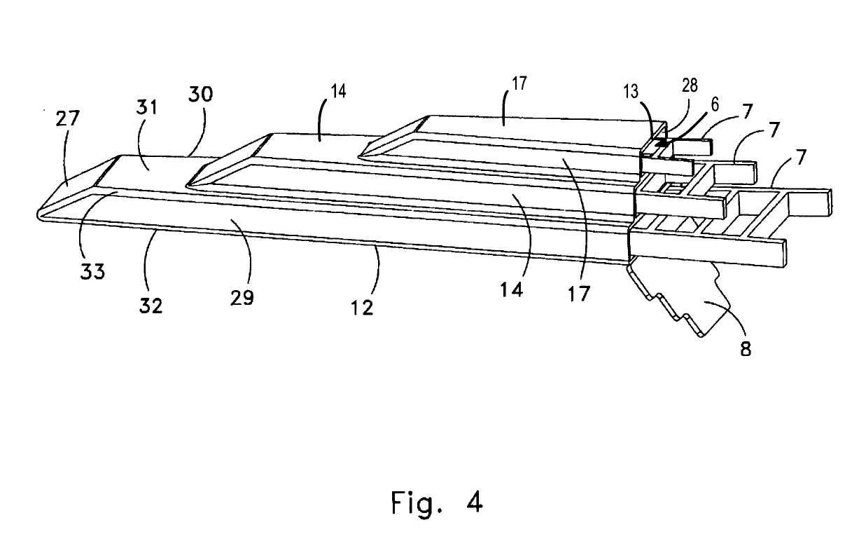

Now referring primarily to FIG. 4, which provides a further embodiment of the ladder caddy (1), the ladder caddy body (12) can provide a plurality of discrete enclosed spaces (6) each of which can be configured contain a correspondingly configured ladder (7) inside and which share a common closure element (8).

As can be easily understood from the foregoing, the basic concepts of the present invention can be embodied in a variety of ways. The invention involves numerous and varied embodiments of a ladder caddy and methods of making and using such ladder cadder whether configured to provide one or a plurality of discrete enclosed spaces configured to contain a ladder or a plurality of ladders.

As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “an enclosed space” should be understood to encompass disclosure of the act of “enclosing space”—whether explicitly discussed or not—and, conversely, were there effectively disclosure of the act of “enclosing space”, such a disclosure should be understood to encompass disclosure of an “enclosed space” and even a “means for enclosing space.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each embodiment of the ladder caddy herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below, if any, are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

We claim:

1. A ladder caddy, comprising:
a. a ladder caddy body, comprising:
i. a ladder caddy body wall; and
ii. a closure element coupled to said ladder caddy body wall, wherein said ladder caddy body wall provides an enclosed space configured to contain at least one ladder, and wherein said closure element operates between an open position and a closed position to allow a ladder to removably stow within said enclosed space;
b. a mount which releasably secures said ladder caddy body to a vehicle.

2. A ladder caddy as described by claim 1, wherein said ladder caddy body wall provides a trapezoidal top and a trapezoidal bottom held a distance apart by a pair of rectangular side panels and a rectangular end panel thereby providing a rectangular end aperture having an open condition and a closed condition by operation of said closure element between said open position and said closed position.

3. A ladder caddy as described by claim 2, wherein said rectangular end panel joins said trapezoidal top and said trapezoidal bottom at an angle.

4. A ladder caddy as described by claim 1, wherein said ladder caddy body wall has a configuration which generates an enclosed space configured as a trapezoidal volume in which a trapezoidal ladder removably stows.

5. A ladder caddy as described by claim 4, further comprising a lock coupled to said closure element which secures said closure element in the closed condition.

6. A ladder caddy as described by claim 1, wherein said ladder caddy body comprises a plurality of discrete ladder caddy bodies each including:
i. a ladder caddy body wall; and
ii. a closure element coupled to said ladder caddy body wall, wherein said ladder caddy body provides an enclosed space configured to contain at least one ladder, and wherein said closure element operates between an open position and a closed position to allow a ladder to removably stow within said enclosed space.

7. A ladder caddy as described by claim 6, wherein each of said plurality of ladder caddy bodies further comprises a securement element which allows a first ladder caddy body of said plurality of ladder caddy bodies to releasably secure to a second ladder caddy body of said plurality of ladder caddy bodies.

8. A ladder caddy as described by claim 1, wherein said enclosed space within said ladder caddy body comprises a plurality of discrete enclosed spaces each of said plurality of discrete enclosed spaces configured to contain one of a plurality of ladders, and wherein each one of said plurality of ladders engages a corresponding one of said plurality of discrete enclosed spaces of said ladder caddy body to maintain a distance between each of said plurality of ladders.

9. A ladder caddy as described by claim 8, further comprising at least one outlier caddy removably couples to said ladder caddy body.

10. A ladder caddy as described by claim 9, wherein said outlier caddy provides an outlier caddy top and an outlier caddy bottom held a distance apart by a first outlier side panel, a second outlier caddy side panel, and an outlier caddy end panel, thereby providing an outlier caddy end aperture having an open condition and a closed condition by operation of said outlier closure element between an open position and a closed position.

11. A ladder caddy as described by claim 10, wherein said outlier caddy provides a compartment configured to hold lengths of pipe at least 8 feet in length.

12. A method of producing a ladder caddy, comprising the steps of:
a. configuring a ladder caddy wall to partially enclose a space in which a ladder removably stows;
b. coupling a closure element to said ladder caddy wall which operates between an open position and a closed position, wherein said closure element in said closed position encloses said space in which said ladder removably stows; and
c. connecting a mount to said ladder caddy wall which releasably secures said ladder caddy body to a vehicle.

13. A method of producing a ladder caddy as described in claim 12, wherein said step of configuring a ladder caddy wall to partially enclose a space in which a ladder removably stows comprises configuring said ladder caddy as a trapezoidal top and a trapezoidal bottom held a distance apart by a pair of rectangular end panels and a rectangular end panel to generate a rectangular end aperture having an open condition and a closed condition by operation of said closure element between said open condition and said closed condition.

14. A method of producing a ladder caddy as described in claim 13, further comprising the step of joining said rectangular end panel to said trapezoidal top and said trapezoidal bottom at an angle.

15. A method of producing a ladder caddy as described in claim 13, generating a trapezoidal volume in which a trapezoidal ladder removably stows by perfoming said steps of:
a. configuring a ladder caddy wall to partially enclose a space in which a ladder removably stows; and
b. coupling a closure element to said ladder caddy wall which operates between an open position and a closed position, wherein said closure element in said closed position encloses said space in which said ladder removably stows,

16. A method of producing a ladder caddy as described in claim 12, further comprising the step of generating a plurality of ladder caddy bodies, and wherein a first of said plurality of ladder caddy bodies releasably secures to a second of said ladder caddy bodies.

17. A method of producing a ladder caddy as described in claim as described in claim 12, further comprising the steps of:
a. generating a plurality of discrete enclosed spaces within said ladder caddy body;
b. stowing one of a plurality of ladders in a corresponding one each of said plurality of discrete enclosed spaces; and
c. configuring said plurality of discrete enclosed spaces to maintain a distance between each one of said plurality of ladders stowed in said plurality of discrete enclosed spaces.

18. A method of producing a ladder caddy as described in claim 12, further comprising the steps of:
a. configuring an outlier caddy wall to partially enclose a space in which at least one length of pipe removably stows;
b. coupling an outlier closure element to said ladder caddy wall which operates between an open position and a closed position, wherein said outlier closure element in said closed position encloses said space in which said at least one length of pipe removably stows; and
c. connecting a mount to said outlier caddy wall which releasably secures said outlier caddy to said ladder caddy body.

19. A method of using a ladder caddy, comprising the steps of:
a. mounting said ladder caddy to a vehicle;
b. opening a closure element coupled to a ladder caddy body wall, wherein said closure element in a closed condition and said ladder caddy wall provide an enclosed space in which a ladder removably stows;
c. stowing said ladder inside said ladder caddy body wall;
d. closing said closure element to contain said ladder within said ladder caddy
e. generating travel in said vehicle to transport said ladder within said ladder caddy from a first location to a second location.

20. A method of using a ladder caddy as described in claim 19, wherein said enclosed space comprises a trapezoidal enclosed space and said ladder comprises a trapezoidal ladder.
